(19) United States
(12) Patent Application Publication
(10) Pub. No.: US 2009/0056084 A1
(43) Pub. Date: Mar. 5, 2009

(54) Buckle for horses

(75) Inventor: Chih-Shun Chang, Nantou County (TW)

Correspondence Address: NIKOLAI & MERSEREAU, P.A., 900 SECOND AVENUE SOUTH, SUITE 820, MINNEAPOLIS, MN, 55402, US

(73) Assignee: Jone-Shou Industrial CO., LTD.

(21) Appl. No.: 11/895,395

(22) Filed: Aug. 27, 2007

(51) Int. Cl. A44B 11/24; B68B 5/00

(52) U.S. Cl. 24/178

(57) ABSTRACT

A buckle includes a main frame made by wires which are bent into desired shape and includes a first frame and a second frame which is smaller than the first frame and connected to the first frame. A tongue has one end pivotably connected to the second frame and the other end of the tongue is stopped by the first frame. At least one coat is mounted to at least one of the first and second frames.

### BACKGROUND OF THE INVENTION

(1) Field of the Invention

The present invention relates to a buckle used on horses and the buckle includes a frame made by wires which bent to be desired shape and protection coats are mounted to the frame.

(2) Description of the Prior Art

A conventional buckle used on belts such as surcingles or driving bits of horses generally includes a frame with a tongue pivotably connected thereto so that the buckle is fixed to one end of a belt and the other end of the belt extends through the frame and the tongue extends through one of positioning holes in the belt to fasten the belt to the hoses. The conventional frame is metal frame and made by way of casting which involves many processes such as trimming, coating and coloring. The shapes of the conventional frames of buckles are restricted to be rectangular and square, besides, the metal frames need a lot of maintenance to keep its outer appearance.

The present invention intends to provide a buckle which is made by bending wires and plastic protection coats are mounted to the frame. The shapes of the frame can be varied and the protection coats can have different colors.

### SUMMARY OF THE INVENTION

The present invention relates to a buckle which comprises a main frame including a first frame and a second frame which is smaller than the first frame and connected to the first frame. A tongue has one end pivotably connected to the second frame and the other end of the tongue is stopped by the first frame. At least one coat is mounted to at least one of the first and second frames.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the buckle of the present invention;

FIG. 2 is a perspective view to show the main frame of the buckle of the present invention;

FIG. 3 is a side cross sectional view to show the buckle of the present invention;

FIG. 4 shows a second embodiment of the buckle of the present invention;

FIG. 5 is a perspective view to show a third embodiment of the main frame of the buckle of the present invention;

FIG. 6 shows the buckle with the main frame in FIG. 5 of the present invention;

FIG. 7 shows a third embodiment of the buckle of the present invention, and

FIG. 8 shows the buckles cooperated with belts are used on a hose.

### DETAILED DESCRIPTION OF THE PREFERRED EMBODIMENTS

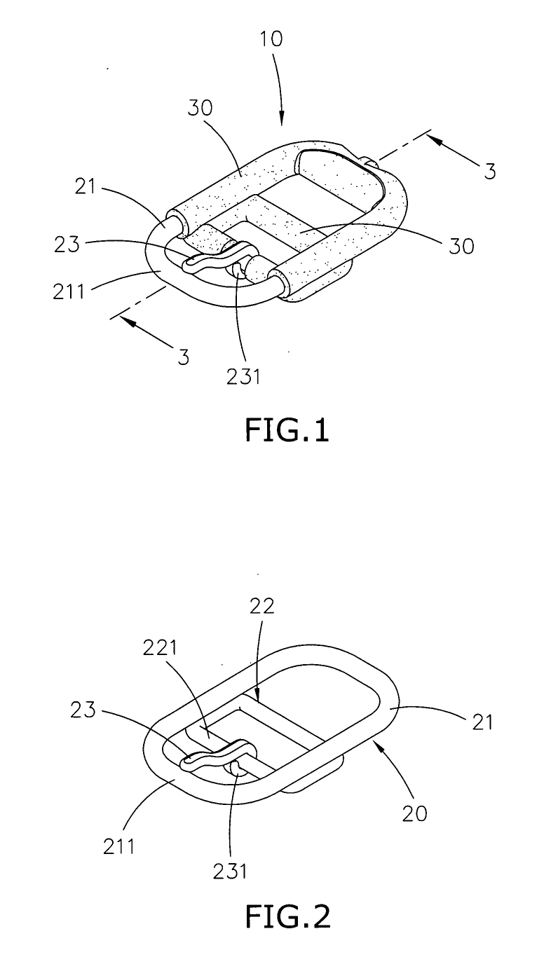

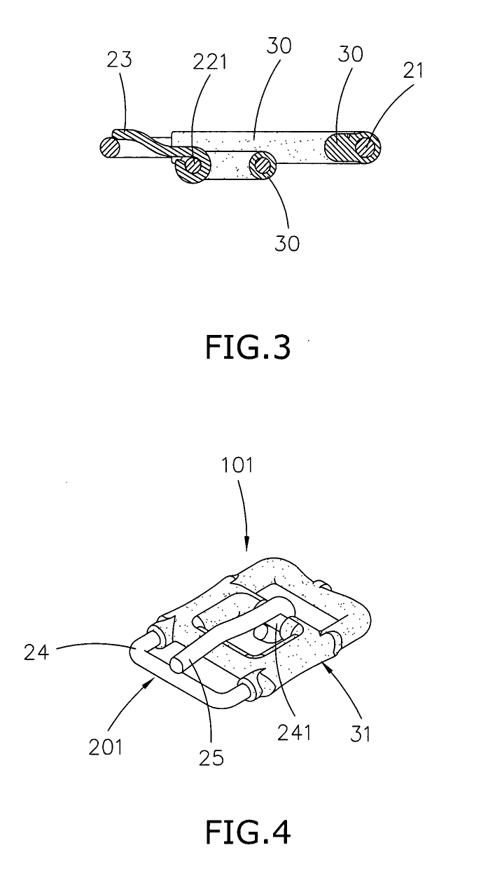

Referring to FIGS. 1 to 3, the buckle 10 of the present invention comprises a main frame 20 which is bent by wires and includes a first frame 21 and a second frame 22 which is smaller than the first frame 21 and is connected to an underside of the first frame 21. A tongue 23 has a ring portion defined in one end thereof which is pivotably connected to a side 221 of the second frame 22 and the other end of the tongue 23 is stopped by the side 211 of the first frame 21. Each of the first and second frames 21, 22 has a coat 30 mounted to. The coat 30 is made by plastic material and can have desired colors. The side 211 that is in contact with the tongue 23 does not have the coat 30 mounted thereto. The coat 30 may have characters, patterns, logos, or any known printed material marked thereon.

FIG. 4 shows a second embodiment of the buckle 101, wherein the second frame (not numbered) is located on the same plane with the first frame 24 of the main frame 201, and the tongue 25 is pivotably connected to one side 241 of the second frame. The coat 31 is coated on a part of the first frame 24 and the second frame and the coat 30 includes different thickness.

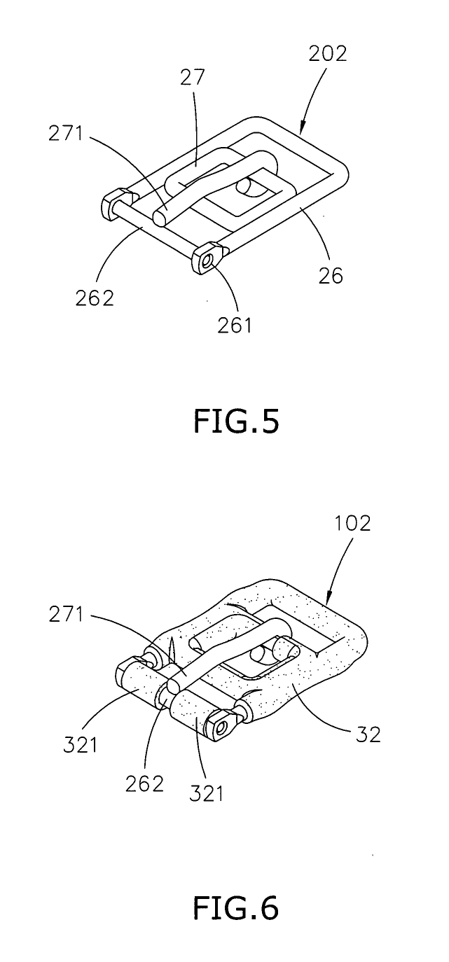

FIGS. 5 and 6 show a third embodiment of the main frame 202 of the buckle 102 of the present invention, wherein the first frame 26 is a U-shaped frame and includes two distal ends, the second frame 27 is connected to the first frame 26 and located on the same plane with the first frame 26. Each of the two distal ends of the first frame 26 has a hole 261 and a rod 262 is connected to the two holes 261. The tongue 271 has one end pivotably connected to the second frame 27 and the other end of the tongue 271 is stopped by the rod 262. The coat 32 is mounted to the first and second frames 26, 27 and two sections of coats 321 are mounted to the rod 262.

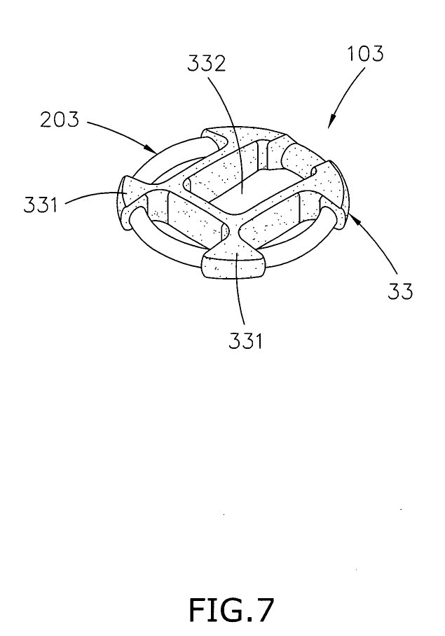

FIG. 7 shows a collar 103 which has a circular first frame 203 and a second frame coated by the coat 33 is located at a center of the collar 103. The coat 33 includes four holding portions 331 connected to the first frame 203. The second frame includes a through hole 332.

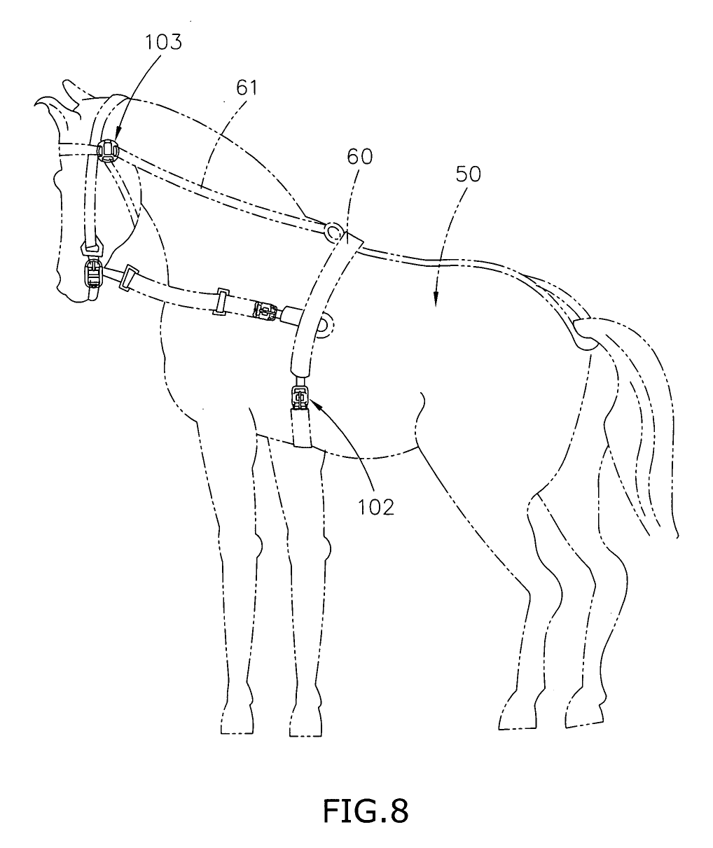

FIG. 8 shows that the buckles 102 and collar 103 of the present invention is cooperated with belts 60 and 61 used on a horse 50.

While we have shown and described the embodiment in accordance with the present invention, it should be clear to those skilled in the art that further embodiments may be made without departing from the scope of the present invention.

1. A buckle comprising:
a main frame including a first frame and a second frame which is smaller than the first frame and connected to the first frame, a tongue having one end pivotably connected to the second frame and the other end of the tongue stopped by the first frame, and
at least one coat mounted to at least one of the first and second frames.

2. The buckle as claimed in claim 1, wherein the at least one coat includes different thicknesses.

3. The buckle as claimed in claim 1, wherein the second frame is connected to an underside of the first frame.

4. The buckle as claimed in claim 1, the second frame is located on the same plane with the first frame.
